(19) United States
(12) Patent Application Publication
(10) Pub. No.: US 2025/0292161 A1
(43) Pub. Date: Sep. 18, 2025

(54) SYSTEM AND METHOD FOR IDENTIFYING TRUE DESTINATION FOR PROVIDING TRUE CAPACITY AVAILABILITY OF A VEHICLE

(71) Applicant: AIRLINES REPORTING CORPORATION, Arlington, VA (US)

(72) Inventors: Shitalkumar Sarangdharrao SABNE, Aldie, VA (US); Nicholas Alexander GARE, Brandon, FL (US)

(73) Assignee: AIRLINES REPORTING CORPORATION, Arlington, VA (US)

(21) Appl. No.: 18/608,276

(22) Filed: Mar. 18, 2024

(51) Int. Cl. G06Q 10/02

(52) U.S. Cl. CPC G06Q 10/025; G06Q 50/14; G06Q 30/0201

(57) ABSTRACT

A method and system for determining a true destination on a ticketed trip including multiple segments, and updating a true vehicle capacity for one or more segments of the ticketed trip are disclosed. The method includes generating at least one stopover code based on at least time-on-ground (TOG), domestic trip indicator, international trip indicator, and geographic location of an airport included in one or more segments. The method further includes grouping the multiple segments based on the at least one stopover code, performing a proration of the grouped segments of the ticketed trip, identifying and storing, in a memory, a true destination based on the grouping, determining and updating a true capacity availability of a vehicle in on at least one of the segments based on the true destination of the ticked trip.

### TECHNICAL FIELD

This disclosure generally relates to a data-driven system and method for distinguishing stopovers from connecting points for a trip with one or more intermittent stops. More specifically, the present disclosure generally relates to a system and method for determining a true destination of a traveler when booking a trip and updating capacity information of a vehicle to reflect true capacity information, which may conflict with capacity information based on ticketed trip information.

### BACKGROUND

The developments described in this section are known to the inventors. However, unless otherwise indicated, it should not be assumed that any of the developments described in this section qualify as prior art merely by virtue of their inclusion in this section, or that those developments are known to a person of ordinary skill in the art.

A user may typically book a trip based on a designated origin and destination. While some trips are direct flights from the designated origin to the designated destination, other trips may include one or more intermittent stops or connection locations before arriving at an eventual destination. Conventionally, it was assumed that the destination indicated on a trip itinerary was the true intended destination. However, this assumption proved not to be correct in many occasions as some users may truly intend a connecting location or intermittent stop as their true destination rather than the destination indicated on a trip itinerary. Accordingly, it's been more difficult to track movements of a user based on itinerary information alone, leading to travel tracking, safety issues as well as incorrect understanding of a vehicle capacity availability, thus providing for less efficient travel.

### SUMMARY

According to an aspect of the present disclosure, a method for determining a true destination on a ticketed trip and updating a true vehicle capacity for one or more segments of the ticketed trip. The method includes obtaining, by a processor, raw data corresponding to the ticketed trip from one or more sources; parsing, by the processor, the raw data and deriving a plurality of segments making up the ticketed trip, each of the plurality of segments including an origin and a destination, and at least one connection point is present between the plurality of segments; generating, by the processor, at least one stopover code based on attributes of the ticketed trip, the attributes including at least time-on-ground, domestic trip indicator, international trip indicator, and geographic location of an airport included in the plurality of segments; grouping, by the processor, the plurality of segments based on the at least one stopover code; creating, by the processor, a trip type for the ticketed trip based on the grouping; performing, by the processor, a proration of the grouped segments of the ticketed trip; dividing and distributing, by the processor, a fare for the ticketed trip according to the performed proration for the grouped segments of the ticketed trip; identifying and storing, by the processor and into a memory, a true destination based on the grouping and the proration performed, wherein the true destination does not match with a destination indicated in the ticketed trip; determining and updating, by the processor, a true capacity availability of a vehicle in on at least one of the plurality of segments based on the true destination of the ticked trip; and displaying, on a display, the true capacity availability of the vehicle that differs from capacity availability of the vehicle indicated by the ticketed trip.

According to another aspect of the present disclosure, the proration is a segment based proration.

According to another aspect of the present disclosure, the segment based proration is performed by: assigning equal percentage to each of the plurality of segments; and applying a sum of the percentages to one or more segments among the plurality of segments that are included between the origin and the true destination.

According to yet another aspect of the present disclosure, the proration is a mileage based proration.

According to another aspect of the present disclosure, the milage based proration is performed by: calculating mileage between an origin and destination of each of the plurality of segments; adding miles of all of the plurality of segments to obtain total mileage for the ticketed trip; dividing mileage of each of the plurality of segments by the total mileage to obtain a percentage of the ticketed trip for each of the plurality of segments; and assigning zero percentage of the ticketed trip for an arrival unknown (ARUNK) segment.

According to a further aspect of the present disclosure, the proration is a fare calculation based proration.

According to yet another aspect of the present disclosure, the fare calculation base proration is performed by: cleaning fare calculation data and deleting duplicates; stitching a plurality of rows of the cleaned fare calculation data to create one or more single strings of characters; searching for patterns including numbers with a decimal value; assigning a sequence number for each of the patterns found based on its respective position, wherein the sequence number assigned is used as a segment number for performing a match; obtaining three alpha characters preceding the patterns, wherein the three alpha characters corresponding to a city code or airport code of a segment; performing a match between the obtained three alpha characters and a segment number corresponding to a segment included in the plurality of segments; and for each of the city code or airport code, associating the city code or the airport code with a corresponding decimal value, and dividing the respective decimal value by a sum of all decimal values for determining a percentage of the segment with respect to the ticketed trip.

According to a further aspect of the present disclosure, the at least one stopover code is generated when the ticketed trip is a domestic trip and TOG is determined to be higher than a reference threshold.

According to another aspect of the present disclosure, the reference threshold is 8 hours for the domestic trip.

According to a further aspect of the present disclosure, the at least one stopover code is generated when the ticketed trip is an international trip and TOG is determined to be higher than a reference threshold.

According to a further aspect of the present disclosure, the reference threshold is 18 hours for the international trip.

According to a further aspect of the present disclosure, the geographic location is a country.

According to a further aspect of the present disclosure, the geographic location is a continent.

According to a further aspect of the present disclosure, the true destination corresponds to a connecting airport that has the TOG above a reference threshold value for a domestic trip.

According to a further aspect of the present disclosure, the true destination corresponds to a connecting airport that has the TOG above a reference threshold value for an international trip.

According to a further aspect of the present disclosure, when the TOG at a connecting airport is above a reference threshold, generating a new OND for a portion of the ticketed trip that indicates the true destination as the respective connecting airport, and identifying remaining portions of the ticked trip as an ARUNK segment with the respective connecting airport being indicated as an origin.

According to a further aspect of the present disclosure, when all of a segment based proration, a mileage based proration and a fare calculation based proration are available for the proration, selecting the fare calculation based proration first, the mileage based proration second and then the segment based proration last based on priority.

According to a further aspect of the present disclosure, the proration determined by the fare calculation based proration is below another reference threshold value, reperforming proration using the mileage based proration.

According to an aspect of the present disclosure, a system for determining a true destination on a ticketed trip and updating a true vehicle capacity for one or more segments of the scheduled trip is provided. The system includes a memory, a display and a processor. The system is configured to perform: obtaining raw data corresponding to the ticketed trip from one or more sources; parsing the raw data and deriving a plurality of segments making up the ticketed trip, each of the plurality of segments including an origin and a destination, and at least one connection point is present between the plurality of segments; generating at least one stopover code based on attributes of the ticketed trip, the attributes including at least time-on-ground, domestic trip indicator, international trip indicator, and geographic location of an airport included in the plurality of segments; grouping the plurality of segments based on the at least one stopover code; creating a trip type for the ticketed trip based on the grouping; performing a proration of the grouped segments of the ticketed trip; dividing and distributing a fare for the ticketed trip according to the performed proration for the grouped segments of the ticketed trip; identifying and storing a true destination based on the grouping and the proration performed, wherein the true destination does not match with a destination indicated in the ticketed trip; determining and updating a true capacity availability of a vehicle in on at least one of the plurality of segments based on the true destination of the ticked trip; and displaying the true capacity availability of the vehicle that differs from capacity availability of the vehicle indicated by the ticketed trip.

According to another aspect of the present disclosure, a method for determining a true fare for a ticketed trip is provided. The method includes obtaining raw data corresponding to the ticketed trip from one or more sources; parsing the raw data and deriving a plurality of segments making up the ticketed trip, each of the plurality of segments including an origin and a destination, and at least one connection point is present between the plurality of segments; generating at least one stopover code based on attributes of the ticketed trip, the attributes including at least time-on-ground, domestic trip indicator, international trip indicator, and geographic location of an airport included in the plurality of segments; grouping the plurality of segments based on the at least one stopover code; creating a trip type for the ticketed trip based on the grouping; performing a proration of the grouped segments of the ticketed trip; and dividing and distributing a fare for the ticketed trip according to the performed proration for the grouped segments of the ticketed trip. The proration is performed by cleaning fare calculation data and deleting duplicates; stitching a plurality of rows of the cleaned fare calculation data to create one or more single strings of characters; searching for patterns including numbers with a decimal value; assigning a sequence number for each of the patterns found based on its respective position, wherein the sequence number assigned is used as a segment number for performing a match; obtaining three alpha characters preceding the patterns, wherein the three alpha characters corresponding to a city code or airport code of a segment; performing a match between the obtained three alpha characters and a segment number corresponding to a segment included in the plurality of segments; and for each of the city code or airport code, associating the city code or the airport code with a corresponding decimal value, and dividing the respective decimal value by a sum of all decimal values for determining a percentage of the segment with respect to the ticketed trip.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a destination determination system in accordance with an exemplary embodiment.

FIG. 2 illustrates an exemplary diagram of a network environment with a destination determination system in accordance with an exemplary embodiment.

FIG. 3 illustrates a system diagram for implementing a destination determination system in accordance with an exemplary embodiment.

FIG. 4 illustrates a method for identifying a true destination of a ticketed trip and partitioning/prorating the ticketed trip for determination of true capacity of a vehicle in accordance with an exemplary embodiment.

FIGS. 5A-5C illustrate a method for identifying a true destination of a ticketed trip and partitioning/prorating the ticketed trip for determination of true capacity of a vehicle in accordance with another exemplary embodiment.

FIGS. 6A-6C illustrate a method for identifying a true destination of a ticketed trip and partitioning/prorating the ticketed trip for determination of true capacity of a vehicle in accordance with another exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

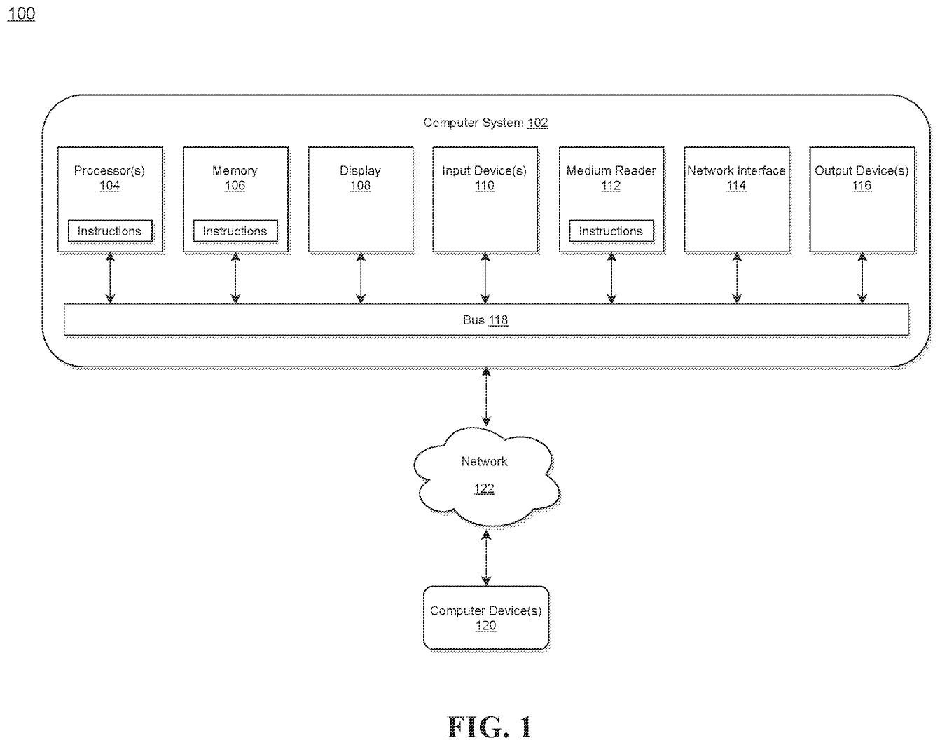

FIG. 1 illustrates a computer system for implementing a destination determination system in accordance with an exemplary embodiment.

The system 100 is generally shown and may include a computer system 102, which is generally indicated. The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The network interface 114 may include, without limitation, a communication circuit, a transmitter or a receiver. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, or the like.

The computer system 102 may be in communication with one or more additional computer devices 120 via a network 122. The network 122 may be, but is not limited thereto, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionality as described herein, and a processor described herein may be used to support a virtual processing environment.

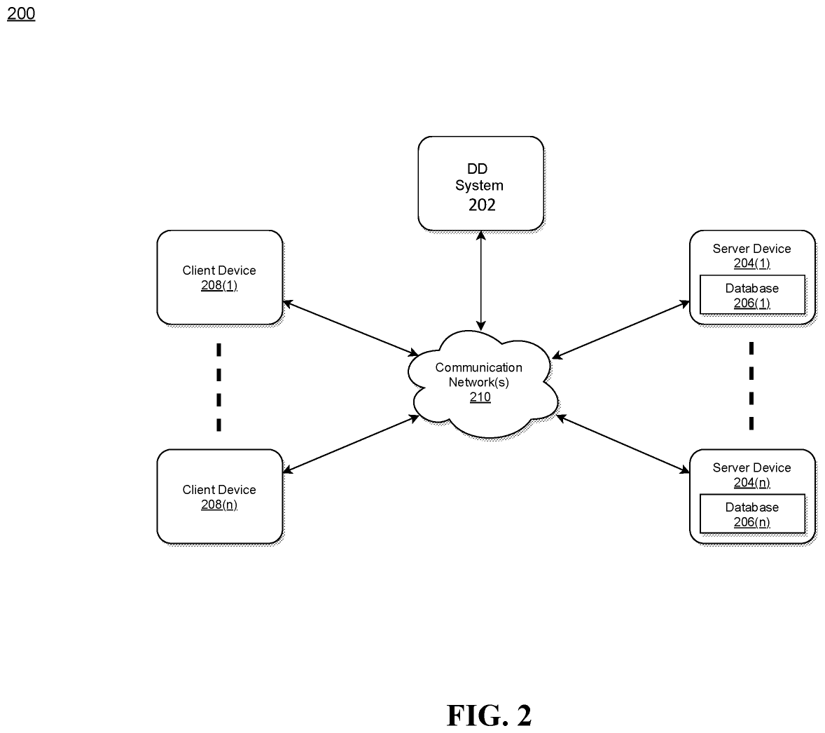

FIG. 2 illustrates an exemplary diagram of a network environment with a destination determination system in accordance with an exemplary embodiment.

A destination determination (DD) system 202 may be implemented with one or more computer systems similar to the computer system 102 as described with respect to FIG. 1.

The destination determination system 202 may store one or more applications that can include executable instructions that, when executed by the destination determination system 202, cause the destination determination system 202 to perform actions, such as to execute, transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment or other networking environments. The application(s) may be executed within or as virtual machine(s) or virtual server(s) that may be managed in a cloud-based computing environment. Also, the application(s), and even the destination determination system 202 itself, may be located in virtual server(s) running in a cloud-based computing environment rather than being tied to one or more specific physical network computing devices. Also, the application(s) may be running in one or more virtual machines (VMs) executing on the destination determination system 202. Additionally, in one or more embodiments of this technology, virtual machine(s) running on the destination determination system 202 may be managed or supervised by a hypervisor.

In the network environment 200 of FIG. 2, the destination determination system 202 is coupled to a plurality of server devices 204(1)-204(n) that hosts a plurality of databases 206(1)-206(n), and also to a plurality of client devices 208(1)-208(n) via communication network(s) 210. According to exemplary aspects, databases 206(1)-206(n) may be configured to store data that relates to distributed ledgers, blockchains, user account identifiers, biller account identifiers, and payment provider identifiers. A communication interface of the destination determination system 202, such as the network interface 114 of the computer system 102 of FIG. 1, operatively couples and communicates between the destination determination system 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the destination determination system 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The destination determination system 202 may be a standalone device or integrated with one or more other devices or apparatuses, such as one or more of the server devices 204(1)-204(n), for example. In one particular example, the destination determination system 202 may be hosted by one of the server devices 204(1)-204(n), and other arrangements are also possible. Moreover, one or more of the devices of the destination determination system 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the destination determination system 202 via the communication network(s) 210 according to the HTTP-based protocol, for example, although other protocols may also be used. According to a further aspect of the present disclosure, in which the user interface may be a Hypertext Transfer Protocol (HTTP) web interface, but the disclosure is not limited thereto.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the destination determination system 202 that may efficiently provide a platform for implementing a cloud native destination determination system module, but the disclosure is not limited thereto.

The client devices 208(1)-208(n) may run interface applications, such as standard web browsers or standalone client applications, which may provide an interface to communicate with the destination determination system 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the destination determination system 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the destination determination system 202, the server devices 204(1)-204(n), or the client devices 208(1)-208(n), for example, may be configured to operate as virtual instances on the same physical machine. For example, one or more of the destination determination system 202, the server devices 204(1)-204(n), or the client devices 208(1)-208(n) may operate on the same physical device rather than as separate devices communicating through communication network(s) 210. Additionally, there may be more or fewer destination determination systems 202, server devices 204(1)-204(n), or client devices 208(1)-208(n) than illustrated in FIG. 2. According to exemplary embodiments, the destination determination system 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

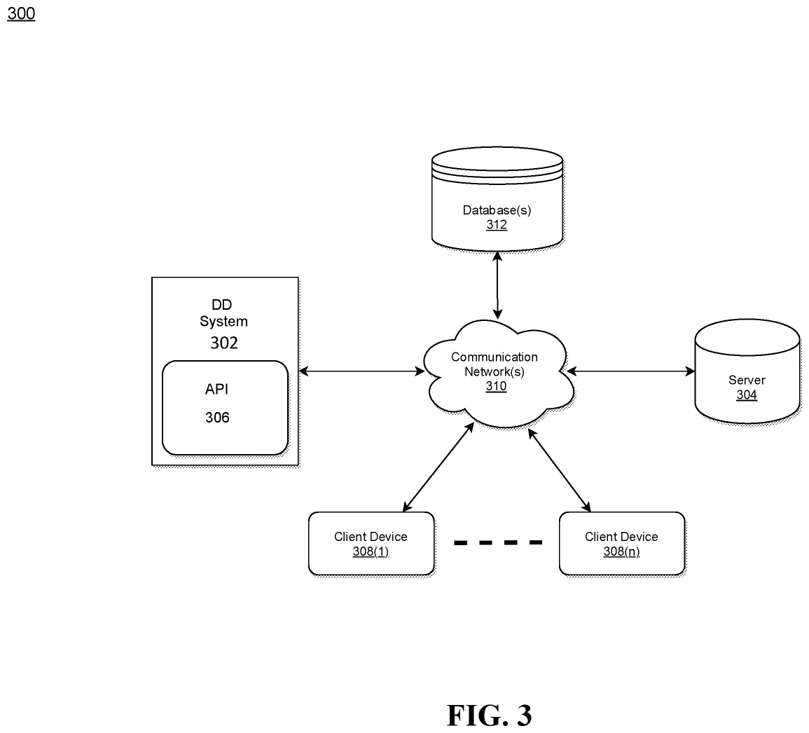

FIG. 3 illustrates a system diagram for implementing a destination determination system in accordance with an exemplary embodiment.

As illustrated in FIG. 3, the system 300 may include a destination determination (DD) system 302 within which a group of API modules 306 is embedded, a server 304, a database(s) 312, a plurality of client devices 308(1) . . . 308(n), and a communication network 310.

According to exemplary embodiments, the destination determination system 302 including the API modules 306 may be connected to the server 304, and the database(s) 312 via the communication network 310. Although there is only one database that has been illustrated, the disclosure is not limited thereto. Any number of databases may be utilized. The destination determination system 302 may also be connected to the plurality of client devices 308(1) . . . 308(n) via the communication network 310, but the disclosure is not limited thereto.

According to exemplary embodiment, the destination determination system 302 is described and shown in FIG. 3 as including the API modules 306, although it may include other rules, policies, modules, databases, or applications, for example. According to exemplary embodiments, the database(s) 312 may be embedded within the destination determination system 302. According to exemplary embodiments, the database(s) 312 may be configured to store configuration details data corresponding to a desired data to be fetched from one or more data sources, but the disclosure is not limited thereto.

According to exemplary embodiments, the API modules 306 may be configured to receive real-time feed of data or data at predetermined intervals from the plurality of client devices 308(1) . . . 308(n) via the communication network 310.

The API modules 306 may be configured to implement a user interface (UI) platform that is configured to enable destination determination system as a service for a desired data processing scheme. The UI platform may include an input interface layer and an output interface layer. The input interface layer may request preset input fields to be provided by a user in accordance with a selection of an automation template. The UI platform may receive user input, via the input interface layer, of configuration details data corresponding to a desired data to be fetched from one or more data sources. The user may specify, for example, data sources, parameters, destinations, rules, and the like. The UI platform may further fetch the desired data from said one or more data sources based on the configuration details data to be utilized for the desired data processing scheme, automatically implement a transformation algorithm on the desired data corresponding to the configuration details data and the desired data processing scheme to output a transformed data in a predefined format, and transmit, via the output interface layer, the transformed data to downstream applications or systems.

The plurality of client devices 308(1) . . . 308(n) are illustrated as being in communication with the destination determination system 302. In this regard, the plurality of client devices 308(1) . . . 308(n) may be “clients” of the destination determination system 302 and are described herein as such. Nevertheless, it is to be known and understood that the plurality of client devices 308(1) . . . 308(n) need not necessarily be “clients” of the destination determination system 302, or any entity described in association therewith herein. Any additional or alternative relationship may exist between either or both of the plurality of client devices 308(1) . . . 308(n) and the destination determination system 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1) . . . 308(n) may communicate with the destination determination system 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The destination determination system 302 may be the same or similar to the destination determination system 202 as described with respect to FIG. 2, including any features or combination of features described with respect thereto.

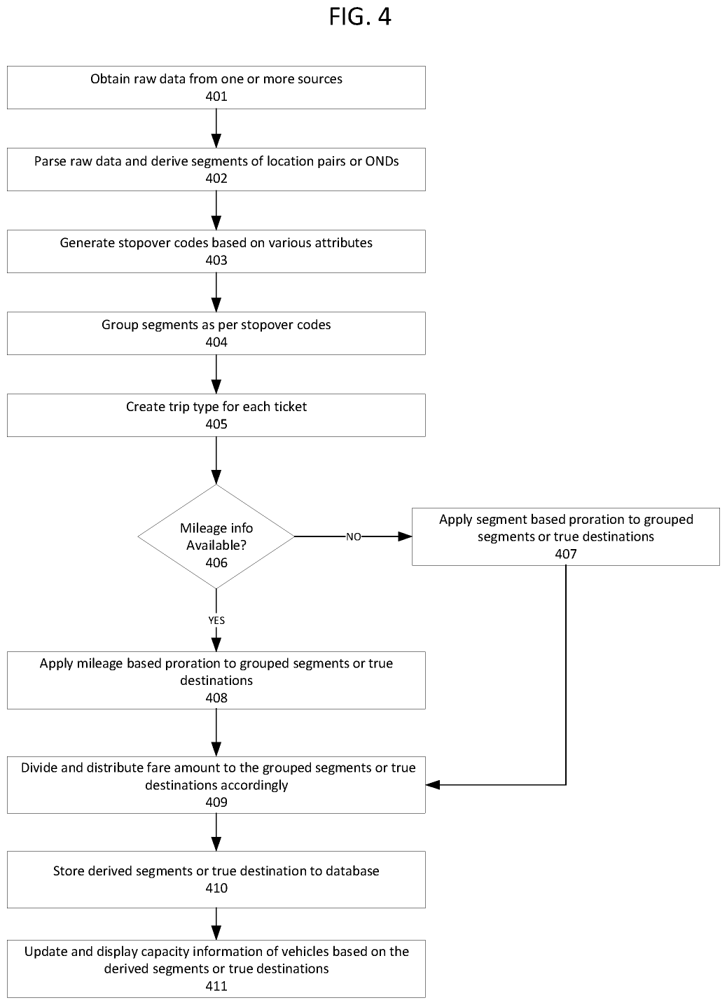

FIG. 4 illustrates a method for identifying a true destination of a ticketed trip and partitioning/prorating the ticketed trip for determination of true capacity of a vehicle in accordance with an exemplary embodiment.

According to exemplary aspects, the present disclosure provides a data driven framework for determining a true destination of a trip where at least one connecting point is included to provide for multiple segments or legs. Each of the segments or legs may include its own origin and destination. One of the origins of the multiple segments may be the true origin of the respective trip, and one of the destinations of the multiple segments may be the true destination of the respective trip. In this regard, the data driven framework establishes a methodology to distinguish a stopover and a layover for one or more connecting points included in the respective trip. In an example, a stopover may refer to an extended layover, which may be defined differently for domestic trips and international trips. Based on such distinctions, components of a trip may be separated into different groups (e.g., valid segments or portions of the trip, and invalid or arrival unknown (ARUNK) segments or portions of the trip), and percentage of a trip may be allocated according to such groupings.

According to exemplary aspects, a true origin-destination (TOD) may be determined for each trip, and fare amount may be prorated according to the TOD. Moreover, the respective trip may be broken down to multiple components and prorated according to a segment level. Each trip may include one or more segments or legs, and each segment or leg may include its respective origin and destination. One of the origins may be the true origin and one of the origins may be the true destination. In an example, the originally specified destination in the trip may be identified as the true destination or one of the connection points in the trip may be identified as the true destination. Based on the identification of the true destination, the TOD may be specified for the respective trip. According to exemplary aspects, the specified origin for the trip may be identified as the true origin. However, aspects of the present disclosure are not limited thereto, such that one of the connection points may be identified as the true origin for determination of the TOD.

According to exemplary aspects, determination of the TOD may be helpful in identifying real traffic movement, as opposed to perceived or assumed traffic movement based on what may be indicated by the origin-destination pairs specified on a trip ticket. Based on the determined TOD, passenger tracking and capacity planning for vehicles may be improved. In an example, based on the determined TOD, it may be determined that a person of interest intended destination may be at a connecting airport as opposed to the destination indicated on a ticketed trip. Moreover, TOD may help to update the capacity information of a vehicle by updating a purchased seat as being vacant for one or more segments of the trip. In an example, true capacity referenced in this disclosure may refer to true performance in the airline industry, which may only be derived if the true intended destination (as opposed to destination indicated on a ticket) of a passenger is known.

According to exemplary aspects, a method for identifying a true origin and destination of a ticketed trip includes TOD determination, TOD and/or proration, derivation of dominant values for marketing carrier, cabin based on reservation booking designator (RBKD), trip type, outbound indicator, and average fare. Such method utilizes data from different channels and carrier contributed transactional data available in the data lake, combines it with the schedule data to calculate the time on ground (TOG). According to exemplary aspects, the method for identifying a true origin and destination of a ticketed trip is an event-driven process, which may trigger automatically once all of the required data are available in the data lake. Results of the event-driven process may be subsequently split and stored separately into different tables.

According to exemplary aspects, a true destination may be determined based on the calculated time on ground. Moreover, based on the determination of true destination, mileage based proration may be allocated. In an example, the time on ground may refer to a connection or wait time between two segments of a trip or journey. Different threshold limit may be utilized for domestic flights and international flights. For example, 8 hours may be utilized as the threshold limit for domestic flights and 18 hours may be utilized as the threshold limit for international flights. However, aspects of the present disclosure are not limited thereto, such that differing threshold values may be set or utilized based on observed data. For example, a machine learning model (ML) may be utilized to intermittently evaluate threshold values and update such threshold values based on processed data.

Accordingly, based on the above noted exemplary threshold values, if the connection time between two legs of a trip or journey is determined to be greater than 8 hours for a domestic flight or greater than 18 hours for an international flight, the respective connection point or airport may be determined to be a true destination. Based on the determination of true origin and/or destination for a trip, each of the remaining arrival not known (ARUNK) trip segment and open segment may be treated as having its own origin and destination.

As illustrated in FIG. 4, in operation 401 raw data is obtained from one or more sources. In an example, data sources may include various travel agencies, airlines, data aggregators and the like. Raw data may include, without limitation, specified origin airport, specified destination airport, connection points or airports, connection times (i.e., waiting time between legs of a trip or journey), travel provider for each leg of trip (e.g., airline), travel time for each leg of a trip, boarding date and time for each leg of a trip, departure date and time for each leg of a trip, arrival date and time for each leg of a trip, flight number, and marketing carrier code. In an example, schedule data (e.g., schedule data including departure time, arrival date and time for all segments included in a trip) may be obtained based on one or more keys related to origin airport, destination airport, flight number, marketing carrier code and departure date.

In operation 402, the received raw data is parsed to derive segments or legs of location pairs. Each of the location pairs may include an origin and a destination. In an example, a leg or segment of a trip may include a pair of locations or airports. More specifically, each leg of the journey may include an origin and a destination (OND). Each of the origin and/or destination may be an original, final or intermittent. For example, a trip may depart from airport A to connecting airport B, before finally arriving at destination airport C. In this example, one leg or segment of the trip may include OND of airport A and airport B, and OND of airport B and airport C. Although two airports are identified as being included in a single leg, aspects of the present disclosure are not limited thereto, such that multiple airports may be included in a single leg.

In operation 403, stopover codes are generated based on one or more attributes. According to exemplary aspects, the one or more attributes may include time on ground, domestic flight indicator, international flight indicator, origin or destination country and the like. In an example, time on ground may be determined for each connecting airport or location, or between each pair of legs or segments. According to exemplary aspects, the time on ground may be indicated in hours. However, aspects of the present disclosure are not limited thereto, such that the time on ground may be indicated in units of days, minutes and/or combination of days, hours, minutes and seconds.

The determined time on ground may be compared against one or more reference thresholds. Different reference thresholds may be utilized for domestic flights and international flights. For example, a reference threshold for domestic flights may be 8 hours and a reference threshold for international flights may be 18 hours. However, aspects of the present disclosure are not limited thereto, such that the reference threshold may be adjusted. In an example, a determination as to whether to compare the time on ground against a reference threshold for domestic flights or against a reference threshold for international flights may be determined based on a country code of the connecting airport or location. For example, if the country code of the connecting airport is different from the preceding airport or respective origin airport, then the connecting airport may be determined to be an international airport and the determined time on ground may be compared against the reference threshold for international flights.

If the time on ground is less than the reference threshold, then the connecting airport or location between a respective pair of legs or segments may be identified as a layover (not a stopover or a termination point) and original OND of the ticketed trip may be maintained. On the other hand, if the time on ground is determined to be greater than or equal to the reference threshold (e.g., 8 hours for domestic flights and 18 hours for international flights), a new OND identifier is generated with the connecting airport or location being identified as the new destination. Upon such determination, a stopover code may be generated for the respective connecting airport or location. A stopover code may indicate a layover (e.g., a connecting location), a true destination or the like. In an example, a stopover code may be generated for one or more of the connecting airport or location for a trip. The remaining segment(s) or legs of the trip, which may be ARNUNK or OPEN segment(s), may be assigned a new OND number or identifier. Further, a new OND number or identifier may be assigned to each segment of the trip where schedule information is not available.

In operation 404, the identified segments of the trip are grouped according to the stopover codes. For example, segments of the trip that is preceded by an overly lengthy time on ground (e.g., over 8 hours for domestic flights) may be grouped together and distinguished from segments of the trip that is preceded by time on ground that is less than the predetermined time on ground (e.g., less than 8 hours for domestic flights), which are grouped together. Also, ARUNK or OPEN segments may be grouped together. In an example, segments of the trip that includes the original origin may be grouped separately, or together with segments that is preceded by time on ground that is less than the predetermined time on ground.

In operation 405, a trip type indicator or designation is created for each trip. According to exemplary aspects, trip types may include, without limitation, one-way (OW), round trip (RT), open jaw (OJ) and complex/circle trip (CT). One way trip type may refer to a trip having a total number of origin and destination (OND) of one. Round trip may refer to a trip where an origin airport is the same as the final destination airport, or a trip where both the origin airport and the final destination airport are co-terminals and the total number of ONDs in a trip is greater than one, and entire transaction has maintained true symmetry (i.e., a departure trip is symmetrical to a return trip). Alternatively, a round tryp may refer to a trip in which an origin airport is the same as the final destination airport, or both the origin airport and the final destination airport both are co-terminals and the number of ONDs in a trip are equal to two ignoring ARUNK OND and no gap in the airport continuity amongst the segments. In an example, co-terminals may refer to two or more airports serving the same metropolitan area. Open jaw may refer to a trip where the origin airport in a departure flight is different from the final destination airport in a return flight, or a trip where the origin airport and the final destination airport are not co-terminals and the total number of ONDs included in a trip is greater than one. Lastly, complex/circle trip may refer to a trip that does not qualify as a one-way trip, round trip, or an open jaw trip.

In operation 406, a determination of whether mileage information is available for the trip. According to exemplary aspects, different types of proration may be utilized. For example, one or more of mileage based proration, segment or OND based proration and fare calculated value based proration may be utilized. In another example, different types of proration may be applied according to priority. More specifically, fare based proration may be performed as a first priority, then followed by mileage proration, which is followed by segment based proration. However, aspects of the present disclosure are not limited thereto, such that different proration approach or approaches may be utilized with differing priority.

If the mileage information is determined not to be available for the trip in operation 406, segment or OND based proration is applied to the grouped segments or true destinations in operation 407. According to exemplary aspects, proration percentage may be equally divided among the number of ONDs included in the ticket. For example, if a ticket includes three ONDs, each OND's percentage would account for 33.33% of the trip.

On the other hand, if the mileage information is determined to be available for the trip in operation 406, mileage based proration is applied to the grouped segments or true destinations in operation 408. According to exemplary aspects, the mileage based proration may be performed using a big circle miles formula. More specifically, the mileage proration may calculate mileage between origin and destination airports of each leg of a trip. Then miles of all segments at both OND level and ticket level may be added to obtain miles of an OND and the total miles of the ticket. Then miles for each of the ONDs or segments may be divided by the total miles to obtain a respective OND percentage for the ticketed trip. In this regard, any ARUNK segment ONDs will account for zero percentage share of the ticket.

Upon applying the segment based proration in operation 407 or applying the mileage based proration in operation 408, the method proceeds to operation 409. In operation 409, fare amount is divided and distributed to the grouped segments of ONDs or true destinations accordingly.

In operation 410, the derived segments of ONDs or true destinations are stored in a database. More specifically, determined true destinations and/or corresponding ONDs (e.g., true or valid ONDs or segments, ARUNK ONDs and open ONDs) may be stored in a database. According to further aspects, passenger information corresponding to the true destination may additionally be stored to allow more accurate tracking of passenger itinerary. According to exemplary embodiments, ONDs or segments indicated on a trip ticket may or may not correspond to the ONDs or segments determined to be true ONDs or segments. In an example, the database may include a single database or a system of databased, which may be located locally, over a network or in a cloud network.

In operation 411, capacity information of vehicles are updated based on the derived segments or true destinations. According to exemplary aspects, capacity information may be updated to reflect true destinations determined for a trip. In an example, for a trip indicating an origin A, connecting airport B, and a final destination C, original capacity information may reflect a seat as being occupied for a segment including origin A and the connecting airport B (i.e., segment AB or OND AB), and a seat being occupied for a segment including connecting airport B and final destination C (i.e., segment BC or OND BC). However, when the true destination of the trip is determined to be the connecting airport B, rather than the indicated final destination of C, the respect seat for segment BC or OND BC may be updated to reflect that it is unoccupied. Such updated seat occupation information may then be reflected and/or displayed on various travel sites to reflect true occupancy information.

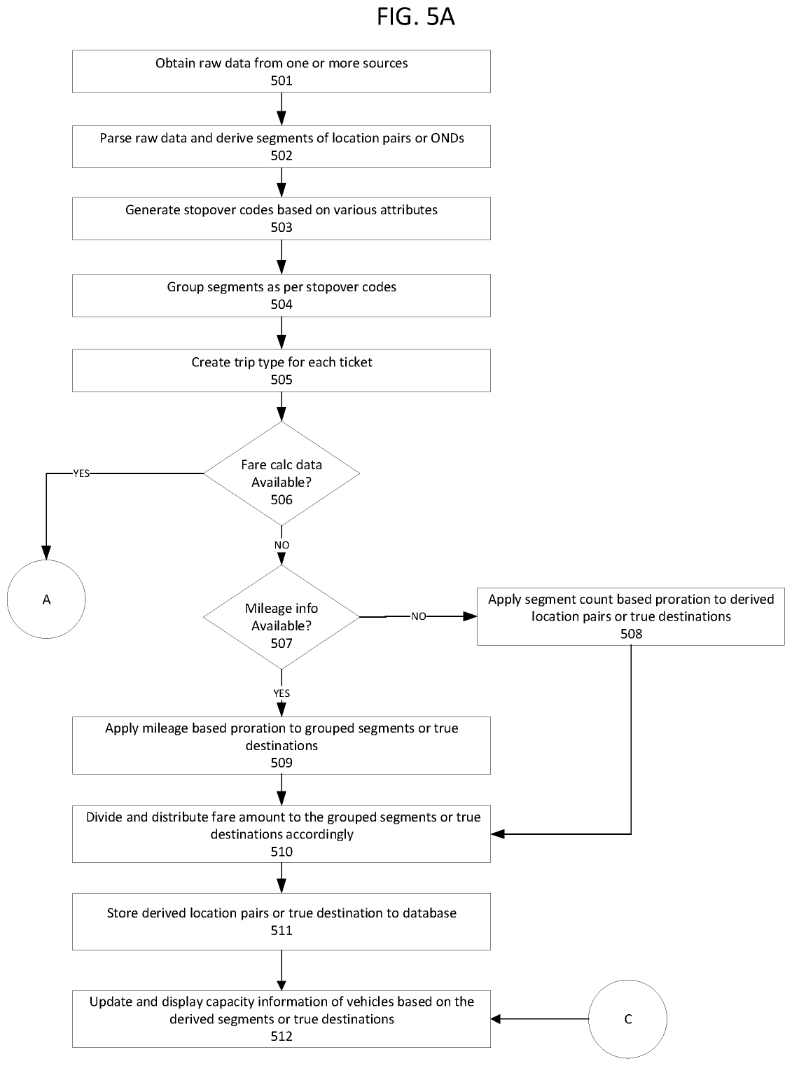

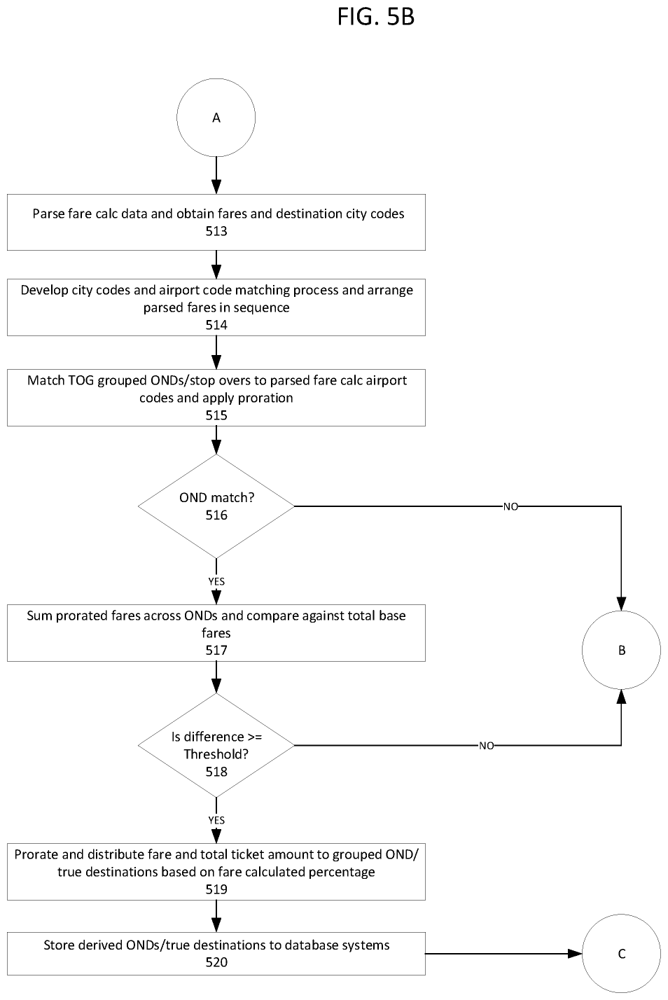

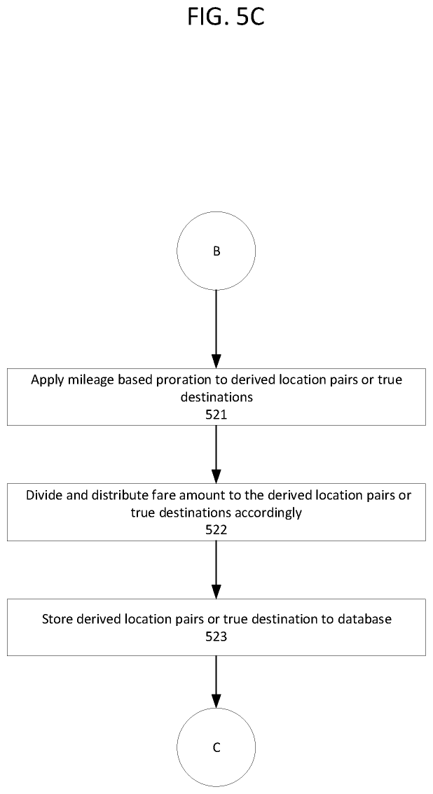

FIGS. 5A-5C illustrate a method for identifying a true destination of a ticketed trip and partitioning/prorating the ticketed trip for determination of true capacity of a vehicle in accordance with another exemplary embodiment.

In operation 501 raw data is obtained from one or more sources. In an example, data sources may include various travel agencies, airlines, data aggregators and the like. Raw data may include, without limitation, specified origin airport, specified destination airport, connection points, connection times (i.e., waiting time between legs of a trip or journey), travel provider for each leg of trip (e.g., airline), travel time for each leg of a trip, boarding date and time for each leg of a trip, departure date and time for each leg of a trip, arrival date and time for each leg of a trip, flight number, and marketing carrier code. In an example, schedule data (e.g., schedule data including departure time, arrival date and time for all segments included in a trip) may be obtained based on one or more keys related to origin airport, destination airport, flight number, marketing carrier code and departure date.

In operation 502, the received raw data is parsed to derive segments of location pairs. According to exemplary aspects, one or more segments or legs of a journey or a trip are determined based on the parsed raw data. In an example, a leg or segment of a trip may include a pair of locations or airports. More specifically, each leg of the journey may include an origin and a destination (OND). Each of the origin and destination may be an original, final or intermittent. For example, a trip may depart from airport A to connecting airport B, before finally arriving at destination airport C. In this example, one leg or segment of the trip may include OND of airport A and airport B, and OND of airport B and airport C. Although two airports are identified as being included in a single leg, aspects of the present disclosure are not limited thereto, such that multiple airports may be included in a single leg.

In operation 503, stopover codes are generated based on one or more attributes. According to exemplary aspects, the one or more attributes may include time on ground, domestic flight indicator, international flight indicator, origin or destination country and the like. In an example, time on ground may be determined for each connecting airport or location, or between each pair of legs or segments. According to exemplary aspects, the time on ground may be indicated in hours.

The determined time on ground may be compared against one or more reference thresholds. Different reference thresholds may be utilized for domestic flights and international flights. For example, a reference threshold for domestic flights may be 8 hours and a reference threshold for international flights may be 18 hours. However, aspects of the present disclosure are not limited thereto, such that the reference threshold may be adjusted. In an example, a determination as to whether to compare the time on ground against a reference threshold for domestic flights or against a reference threshold for international flights may be determined based on a country code of the connecting airport or location. For example, if the country code of the connecting airport is different from the preceding airport or respective origin airport, then the connecting airport may be determined to be an international airport and the determined time on ground may be compared against the reference threshold for international flights.

If the time on ground is less than the reference threshold, then the connecting airport or location between a respective pair of legs or segments may be identified either as a layover and original OND may be maintained. On the other hand, if the time on ground is determined to be greater than or equal to the reference threshold (e.g., 8 hours for domestic flights and 18 hours for international flights), a new OND identifier is generated with the connecting airport or location being identified as the new destination. The remaining segment(s) or legs of the trip, which may be ARNUNK or OPEN segment(s), may be assigned a new OND number or identifier. Further, a new OND number or identifier may be assigned to each segment where schedule information is not available. Upon such determination, a stopover code may be generated for the respective connecting airport or location. A stopover code may be generated for one or more of the connecting airport or location for a trip.

In operation 504, the identified segments of the trip are grouped according to the stopover codes. For example, segments of the trip that is preceded by an overly lengthy time on ground (e.g., over 8 hours for domestic flights) may be grouped together and distinguished from segments of the trip that is preceded by time on ground that is less than the predetermined time on ground (e.g., less than 8 hours for domestic flights), which are grouped together. In an example, segments of the trip that includes the original origin may be grouped separately, or together with segments that is preceded by time on ground that is less than the predetermined time on ground.

In operation 505, a trip type indicator or designation is created for each trip. According to exemplary aspects, trip types may include, without limitation, one-way (OW), round trip (RT), open jaw (OJ) and complex/circle trip (CT). One way trip type may refer to a trip having a total number of origin and destination (OND) of one. Round trip may refer to a trip where an origin airport is the same as the final destination airport, or a trip where both the origin airport and the final destination airport are co-terminals and the total number of ONDs in a trip is greater than one, and entire transaction has maintained true symmetry (i.e., a departure trip is symmetrical to a return trip). Alternatively, a round tryp may refer to a trip in which an origin airport is the same as the final destination airport, or both the origin airport and the final destination airport both are co-terminals and the number of ONDs in a trip are equal to two ignoring ARUNK OND and no gap in the airport continuity amongst the segments. In an example, co-terminals may refer to two or more airports serving the same metropolitan area. Open jaw may refer to a trip where the origin airport in a departure flight is different from the final destination airport in a return flight, or a trip where the origin airport and the final destination airport are not co-terminals and the total number of ONDs included in a trip is greater than one. Lastly, complex/circle trip may refer to a trip that does not qualify as a one-way trip, round trip, or an open jaw trip.

In operation 506, a determination of whether fare calculation data is available for the trip. According to exemplary aspects, fare calculation data may include information that may be utilized to determine how much of the trip fare is attributed to each leg or segment of the trip. According to exemplary aspects, the fare calculation data may correspond to mileage of each leg or segment of the trip, based on demand for the respective leg or segment, based on availability of seats for the respective leg or segment, or the like.

If the fare calculation is determined not to be available in operation 506, then the method proceeds to operation 507. However, if the fare calculation is determined to be available in operation 506, then the method proceeds to operation 513 on FIG. 5B.

In operation 507, a determination of whether mileage information is available for the trip is performed. According to exemplary aspects, different types of proration may be utilized. For example, one or more of mileage based proration, segment or OND based proration and fare calculated value based proration may be utilized. In another example, different types of proration may be applied according to priority. More specifically, fare based proration may be performed as a first priority, then followed by mileage proration, which is followed by segment based proration. However, aspects of the present disclosure are not limited thereto, such that different proration approach or approaches may be utilized with differing priority.

If the mileage information is determined not to be available for the trip in operation 507, segment or OND based proration is applied to the grouped segments or true destinations in operation 508. According to exemplary aspects, proration percentage may be equally divided among the number of ONDs included in the ticket. For example, if a ticket includes three ONDs, each OND's percentage would account for 33.33% of the trip.

On the other hand, if the mileage information is determined to be available for the trip in operation 507, mileage based proration is applied to the grouped segments or true destinations in operation 509. According to exemplary aspects, the mileage based proration may be performed using a big circle miles formula. More specifically, the mileage proration may calculate mileage between origin and destination airports of each leg of a trip. Then miles of all segments at both OND level and ticket level may be added to obtain miles of an OND and the total miles of the ticket. Then miles for each of the ONDs may be divided by the total miles to obtain an OND percentage. In this regard, any ARUNK segment ONDs will account for zero percentage share of the ticket.

Upon applying the segment based proration in operation 508 or applying the mileage based proration in operation 509, the method proceeds to operation 510. In operation 510, fare amount is divided and distributed to the grouped segments of ONDs or true destinations accordingly.

In operation 511, the derived segments of ONDs or true destinations are stored in a database. More specifically, determined true destinations and/or corresponding ONDs (e.g., true or valid ONDs or segments, ARUNK ONDs and open ONDs) may be stored in a database. According to exemplary embodiments, ONDs or segments indicated on a trip ticket may or may not correspond to the ONDs or segments determined to be true ONDs or segments. In an example, the database may include a single database or a system of databased, which may be located locally, over a network or in a cloud network.

In operation 512, capacity information of vehicles are updated based on the derived segments or true destinations. According to exemplary aspects, capacity information may be updated to reflect true destinations determined for a trip. For example, for a trip indicating an origin A, connecting airport B, and a final destination C, original capacity information may reflect a seat as being occupied for a segment including origin A and the connecting airport B (i.e., segment AB or OND AB), and a seat being occupied for a segment including connecting airport B and final destination C (i.e., segment BC or OND BC). However, when the true destination of the trip is determined to be the connecting airport B, rather than the indicated final destination of C, the respect seat for segment BC or OND BC may be updated to reflect that it is unoccupied. Such updated seat occupation information may then be reflected and/or displayed on various travel sites to reflect true occupancy information.

In operation 513, the fare calculation data for a trip may be parsed to obtain fares and destination city codes. In an example, the fare calculation data may be separated into separate legs or segments, each segment or leg of a trip may be stored in each row of the fare calculation data. According to exemplary aspects, fare calculation data may be provided by various sources, and may include more information than what is required for proration of the trip. In an example, some of the information collected may not be necessary for the proration of the trip and may be deleted to conserve computer memory storage. In another example, some of the information collected may include sensitive information, which may be removed or masked to maintain data privacy. In this regard, the fare calculation data may be parsed to extract select information for proration of the trip. For example, select information may include fares based and destination city codes. Other information that are not deemed necessary for proration of the trip and/or otherwise deemed sensitive may be removed or deleted from memory. The select extracted information may be arranged to align with an OND definition of the respective trip.

In operation 514, additional processing is performed to develop city codes for performing a matching operation with airport codes. According to exemplary aspects, the extracted fare calculation data may be cleaned to eliminate duplicate information. Once the developed city codes are matched with the airport codes, multiple rows of the extracted fare calculation data for the respective trip may be stitched together to create a single string of characters. Accordingly, a single string of characters may correspond to a single ticketed trip even if the ticketed trip may include one or more ONDs or segments. Based on these strings, a pattern with numbers with a decimal points is searched for. For each pattern found, a sequence number corresponding to its position is assigned. This sequence number may be utilized as an OND number for performing a match. In addition to the number search, a predetermined number (e.g., three) of alphabetic characters preceding the number pattern is obtained. This predetermined number of alphabetic characters correspond to a city or airport code of the OND.

In operation 515, matching operation is performed for each of the ONDS identified as a stopover based on the TOG. For example, the grouping operation may identify a first group of ONDs with TOG less than a predetermined threshold, and a second group of ONDs with TOG of greater than the predetermined threshold. In this example, the second group of ONDs may be identified as stopovers, whereas the first group of ONDS may be identified as layovers or parts of the original trip. Matching operation may be performed for the ONDs identified as stopovers with parsed fare calculation airport codes, for prorating the respective ONDs based on the fare calculation data.

According to exemplary aspects, from transaction data associated with the ticketed trip, city code of the destination airport of an OND may be obtained, and the obtained city code is then matched with the city code included in the string of characters. Matching should be performed on both city codes and the OND number between the fare calculation data and the transactional data.

In operation 516, a determination of whether the OND matches with a parsed fare calculation airport code is made. If a match is found, the operation proceeds to operation 517. However, if no match is found, the operation proceeds to operation 521 on FIG. 5C.

In the case of an ARUNK in the transactional data, the next OND number and the destination city or airport code is in the source data is matched to the previous OND number and city code in the fare calculation OND. When a match is found, OND number of fares calculation OND is moved by 1, and an ARUNK segment found in the source/transactional data is inserted.

According to exemplary aspects, double ARUNKS may have some gaps in reassigning and may not get aligned between the TOG and the fare calculation. Any additional OND or segment found in fare calculation may be ignored when all ONDs and TOGs get aligned with fare calculation OND. According to exemplary aspects, this operation may be performed for each ARUNK segment found in the source/transactional data.

In operation 517, prorated fares for each of the ONDs included in the respective trip are summed up and compared against the total base fare or the original amount paid for the respective ticketed trip.

In operation 518, if the summed up prorated fares and the total base fare is determined to be greater than or equal to a reference threshold percentage (e.g., 90%) of the total base fare, then the method proceeds to operation 519. On the other than, if the summed up prorated fares is determined to be less than the reference threshold percentage of the total base fare, then the method proceeds to operation to operation 521 on FIG. 5C.

In operation 519, total base fare or total ticket amount is prorated and distributed to the true OND(s) based on the fare calculated percentage. According to exemplary aspects, each of the city codes found in operation 514 gets associated with the corresponding decimal value, and divided by the sum of all of the decimal values from all cities identified. The calculation results in expected percentage of the OND indicated in the ticketed trip.

In operation 520, the derived OND or true destinations are stored in data systems. More specifically, determined true destinations and/or corresponding ONDs (e.g., true or valid ONDs or segments, ARUNK ONDs and open ONDs) may be stored in a database. According to exemplary embodiments, ONDs or segments indicated on a trip ticket may or may not correspond to the ONDs or segments determined to be true ONDs or segments. In an example, the database may include a single database or a system of databased, which may be located locally, over a network or in a cloud network.

Upon storing of the derived OND or true destinations in operation 520, the method proceeds to operation 512 in FIG. 5A for updating capacity information of vehicles based on the derived segments or true destinations.

In operation 521, mileage based proration is applied to the grouped segments or true destinations. According to exemplary aspects, the mileage based proration may be performed using a big circle miles formula. More specifically, the mileage proration may calculate mileage between origin and destination airports of each leg of a trip. Then miles of all segments at both OND level and ticket level may be added to obtain miles of an OND and the total miles of the ticket. Then miles for each of the ONDs may be divided by the total miles to obtain an OND percentage. In this regard, any ARUNK segment ONDs will account for zero percentage share of the ticket.

In operation 522, fare amount is divided and distributed to the grouped segments of ONDs or true destinations accordingly.

In operation 523, the derived segments of ONDs or true destinations are stored in a database. More specifically, determined true destinations and/or corresponding ONDs (e.g., true or valid ONDs or segments, ARUNK ONDs and open ONDs) may be stored in a database. According to exemplary embodiments, ONDs or segments indicated on a trip ticket may or may not correspond to the ONDs or segments determined to be true ONDs or segments. In an example, the database may include a single database or a system of databased, which may be located locally, over a network or in a cloud network.

Upon storing of the derived OND or true destinations in operation 523, the method proceeds to operation 512 in FIG. 5A for updating capacity information of vehicles based on the derived segments or true destinations.

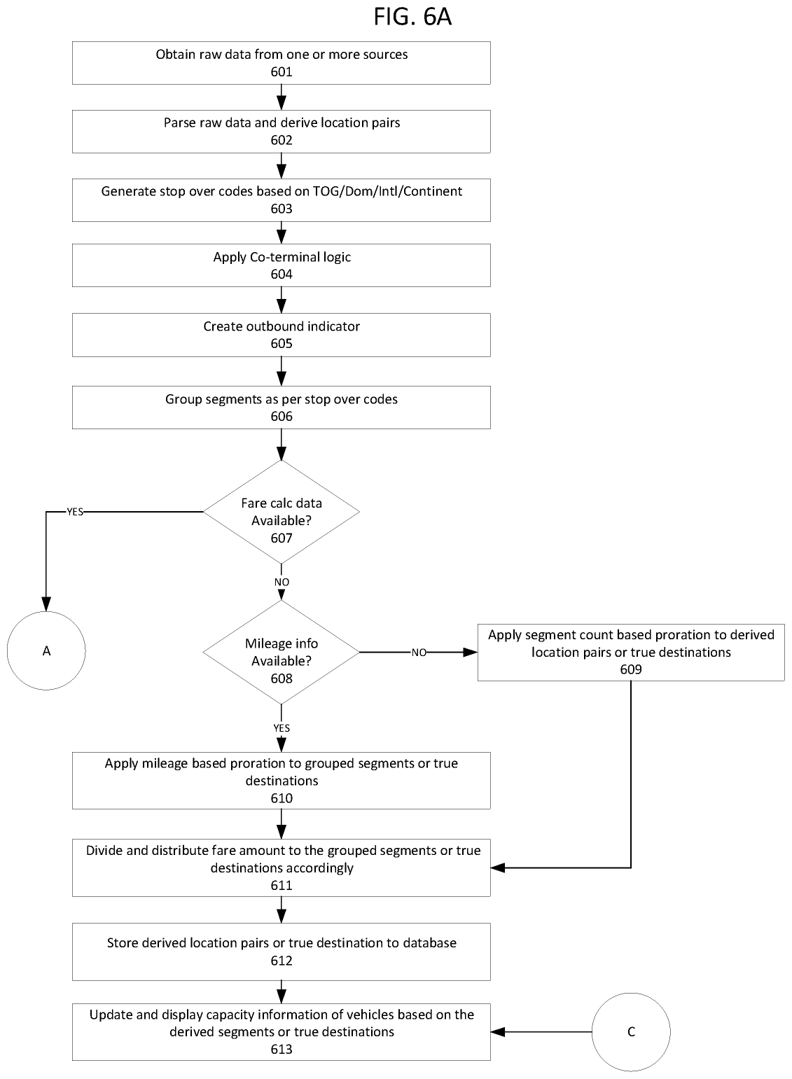

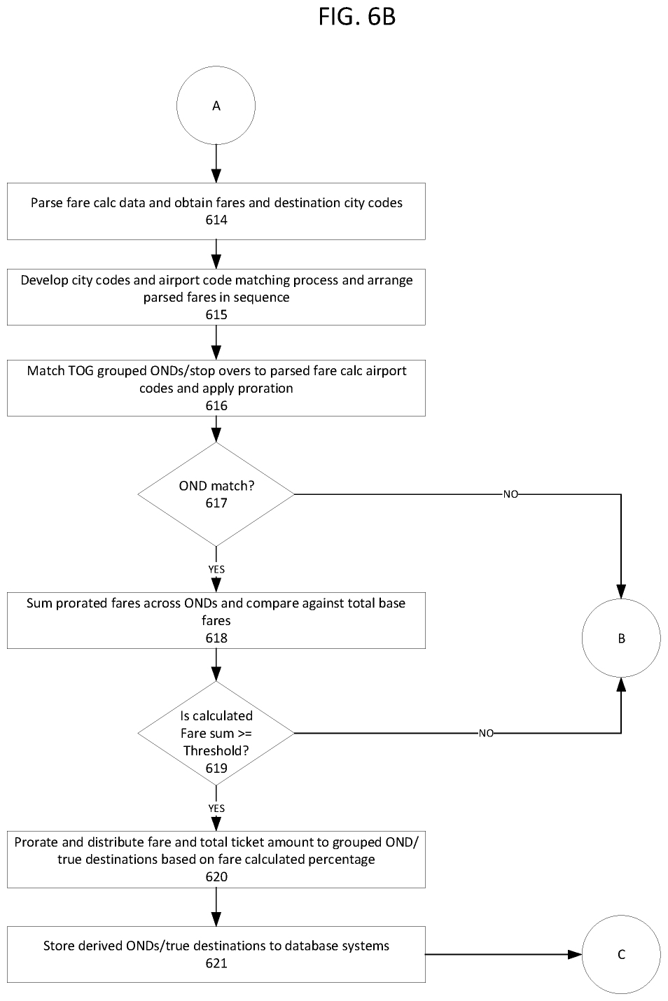

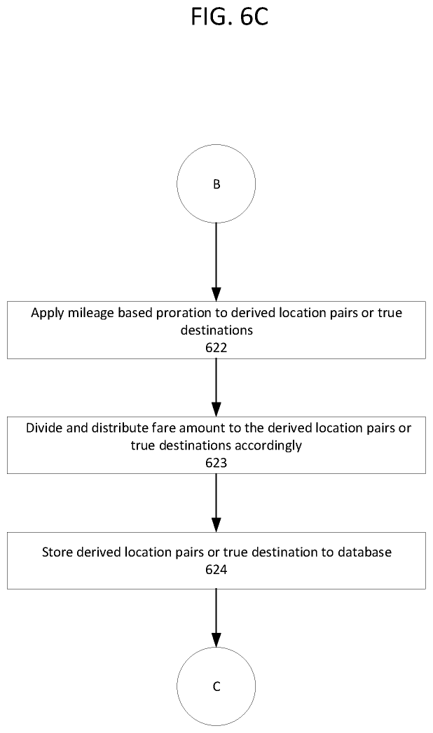

FIGS. 6A-6C illustrate a method for identifying a true destination of a ticketed trip and partitioning/prorating the ticketed trip for determination of true capacity of a vehicle in accordance with another exemplary embodiment.

According to exemplary aspects, the exemplary aspects illustrated in FIGS. 6A-6C may enhance fall back if a reference threshold (e.g., 90%) of base fare per ticket is not constructed by the fare calculation method.

In operation 601 raw data is obtained from one or more sources. In an example, data sources may include various travel agencies, airlines, data aggregators and the like. Raw data may include, without limitation, specified origin airport, specified destination airport, connection points, connection times (i.e., waiting time between legs of a trip or journey), travel provider for each leg of trip (e.g., airline), travel time for each leg of a trip, boarding date and time for each leg of a trip, departure date and time for each leg of a trip, arrival date and time for each leg of a trip, flight number, and marketing carrier code. In an example, schedule data (e.g., schedule data including departure time, arrival date and time for all segments included in a trip) may be obtained based on one or more keys related to origin airport, destination airport, flight number, marketing carrier code and departure date.

In operation 602, the received raw data is parsed to derive segments of location pairs. According to exemplary aspects, one or more segments or legs of a journey or a trip are determined based on the parsed raw data. In an example, a leg or segment of a trip may include a pair of locations or airports. More specifically, each leg of the journey may include an origin and a destination (OND). Each of the origin and destination may be an original, final or intermittent. For example, a trip may depart from airport A to connecting airport B, before finally arriving at destination airport C. In this example, one leg or segment of the trip may include OND of airport A and airport B, and OND of airport B and airport C. Although two airports are identified as being included in a single leg, aspects of the present disclosure are not limited thereto, such that multiple airports may be included in a single leg.

In operation 603, stopover codes are generated based on one or more of TOG, domestic or international indicator, or based on continent information. According to exemplary aspects, if a schedule trip includes multiple segments or legs, and a series of connection points with layovers being less than a reference threshold (e.g., 8 hours for domestic flights, and 18 hours for international flights) resulting in the trip having the same airport (e.g., origin and destination both being TPA), multiple checks may be performed to break the respective trip into multiple parts.

In operation 604, co-terminal logic is applied. According to exemplary aspects, co-terminal logic may firstly perform a check to determine if the trip is a symmetrical round trip (e.g., TPA->DFW (with 6 hour layover at DFW), DFW->TPA). According to exemplary aspects, a symmetrical trip may refer to a trip in which a passenger travels to the same pair of airports on both onward and return parts of the trip. For example, on the onward or first part of the trip, the passenger may stop at connecting points or airports A, B and C, and on the return or second part of the trip, the passenger may stop by connecting points or airports C, B and A (i.e., same connecting points but in differing sequence). For symmetry validation, co-terminals and ARUNKS may be taken into consideration.

In this regard, special cases may be applicable. For example, when an ARUNK exists in the source data and the miles between the ARUNK airports is within a refence distance (e.g., 75 miles), then symmetry may be maintained as there may not be a second ARUNK in the return part of the trip.

When there are no ARUNK airports and there is a gap in the airport continuity, mileage between two airports (e.g., departure of the current segment and arrival of previous segment) is determined. If the mileage is determined to be less than the reference threshold, symmetry should be maintained. However, if the determined mileage is equal to or greater than the reference threshold, symmetry is not to be maintained and the trip should be broken into separate parts.

Further, if the point of origin airport is not the same as the final destination of the trip, mileage between the point-of-origin airport (POOA) and the final determination is determined. In this case, if the mileage is determined to be less than the reference threshold, symmetry should be maintained. However, if the determined mileage is equal to or greater than the reference threshold, symmetry is not to be maintained and the trip should be broken into separate parts.

If none of the above noted circumstances are applicable, ticketed trip is determined not to be symmetrical.

Secondly, if the trip is determined to be a non-symmetrical trip, perform a break in the trip at an airport that is located furthest miles away from the connection airport.

Thirdly, if the trip does not fit into the above noted conditions, then a special stopover code or a null value is utilized to break the respective trip into multiple parts.

In operation 605, an outbound indicator is created. According to exemplary aspects, an outbound indicator may show a direction of a trip, whether it is a departing flight or a return flight. In an example, the departing or onward flight may have a value of “Y” for the outbound indicator, and the return flight may have a value of “N” for the outbound indicator.

Rules for assigning the outbound indicator may include the following four rules. First, first segment of the ticketed trip will have an outbound indicator of “Y”. Second, in the case where the trip type is indicated as a round trip, and lack true symmetry but there is continuity in airports, the last leg or segment of the ticketed trip will have the outbound indicator of “N”, while remaining legs or segments of the ticketed trip will have a value of “Y”. Third, an outbound indicator will be set as “N” when an origin airport of a segment match with a destination airport of the next immediate segment. All subsequent segments including the matched destination segment airport segment will be marked as “N”. Fourth, in cases of complex trips, where a person can travel multiple times between the same OND pairs on the same ticketed trip, the outbound indicator may be set as “Y” only for the first occurrence. Once the respective person turns back for the first time, all subsequent segments will be all shown as “N” for the outbound indicator.

Moreover, intra-continent and inter-continent trip break enhancement may be provided. According to exemplary aspects, a reference TOG values (e.g., 8 hours for domestic trips and 18 for international trips) may be applied based on origin and destination continent, instead of countries. In an example, 18 hour TOG limit may be applied for the same continent leg or segment if previous leg or segment of the same trip involves a different continent origin and/or destination.

In operation 606, segments are grouped according to stopover codes. For example, segments of the trip that is preceded by an overly lengthy time on ground (e.g., over 8 hours for domestic flights) may be grouped together and distinguished from segments of the trip that is preceded by time on ground that is less than the predetermined time on ground (e.g., less than 8 hours for domestic flights), which are grouped together. In an example, segments of the trip that include the original origin airport may be grouped separately, or together with segments that is preceded by time on ground that is less than the predetermined time on ground.

In operation 607, a determination of whether fare calculation data is available for the trip is performed. According to exemplary aspects, fare calculation data may include information that may be utilized to determine how much of the trip fare is attributed to each leg or segment of the trip. According to exemplary aspects, the fare calculation data may correspond to mileage of each leg or segment of the trip, based on demand for the respective leg or segment, based on availability of seats for the respective leg or segment, or the like.

If the fare calculation is determined not to be available in operation 607, then the method proceeds to operation 608. However, if the fare calculation is determined to be available in operation 607, then the method proceeds to operation 614 on FIG. 6B.

In operation 608, a determination of whether mileage information is available for the trip. According to exemplary aspects, different types of proration may be utilized. For example, one or more of mileage based proration, segment or OND based proration and fare calculated value based proration may be utilized. In another example, different types of proration may be applied according to priority. More specifically, fare based proration may be performed as a first priority, then followed by mileage proration, which is followed by segment based proration. However, aspects of the present disclosure are not limited thereto, such that different proration approach or approaches may be utilized with differing priority.

If the mileage information is determined not to be available for the trip in operation 608, segment or OND based proration is applied to the grouped segments or true destinations in operation 609. According to exemplary aspects, proration percentage may be equally divided among the number of ONDs included in the ticket. For example, if a ticket includes three ONDs, each OND's percentage would account for 33.33% of the trip.

On the other hand, if the mileage information is determined to be available for the trip in operation 608, mileage based proration is applied to the grouped segments or true destinations in operation 610. According to exemplary aspects, the mileage based proration may be performed using a big circle miles formula. More specifically, the mileage proration may calculate mileage between origin and destination airports of each leg of a trip. Then miles of all segments at both OND level and ticket level may be added to obtain miles of an OND and the total miles of the ticket. Then miles for each of the ONDs may be divided by the total miles to obtain an OND percentage. In this regard, any ARUNK segment ONDs will account for zero percentage share of the ticket.

Upon applying the segment based proration in operation 609 or applying the mileage based proration in operation 610, the method proceeds to operation 611. In operation 611, fare amount is divided and distributed to the grouped segments of ONDs or true destinations accordingly.

In operation 612, the derived segments of ONDs or true destinations are stored in a database. More specifically, determined true destinations and/or corresponding ONDs (e.g., true or valid ONDs or segments, ARUNK ONDs and open ONDs) may be stored in a database. According to exemplary embodiments, ONDs or segments indicated on a trip ticket may or may not correspond to the ONDs or segments determined to be true ONDs or segments. In an example, the database may include a single database or a system of databased, which may be located locally, over a network or in a cloud network.

In operation 613, capacity information of vehicles are updated based on the derived segments or true destinations. According to exemplary aspects, capacity information may be updated to reflect true destinations determined for a trip. For example, for a trip indicating an origin A, connecting airport B, and a final destination C, original capacity information may reflect a seat as being occupied for a segment including origin A and the connecting airport B (i.e., segment AB or OND AB), and a seat being occupied for a segment including connecting airport B and final destination C (i.e., segment BC or OND BC). However, when the true destination of the trip is determined to be the connecting airport B, rather than the indicated final destination of C, the respect seat for segment BC or OND BC may be updated to reflect that it is unoccupied. Such updated seat occupation information may then be reflected and/or displayed on various travel sites to reflect true occupancy information.

In operation 614, the fare calculation data for a trip may be parsed to obtain fares and destination city codes. In an example, the fare calculation data may be separated into separate legs or segments, each segment or leg of a trip may be stored in each row of the fare calculation data. According to exemplary aspects, fare calculation data may be provided by various sources, and may include more information than what is required for proration of the trip. In an example, some of the information collected may not be necessary for the proration of the trip and may be deleted to conserve computer memory storage. In another example, some of the information collected may include sensitive information, which may be removed or masked to maintain data privacy. In this regard, the fare calculation data may be parsed to extract select information for proration of the trip. For example, select information may include fares based and destination city codes. Other information that are not deemed necessary for proration of the trip and/or otherwise deemed sensitive may be removed or deleted from memory. The select extracted information may be arranged to align with an OND definition of the respective trip.

In operation 615, additional processing is performed to develop city codes for performing a matching operation with airport codes. According to exemplary aspects, the extracted fare calculation data may be cleaned to eliminate duplicate information. Once the developed city codes are matched with the airport codes, multiple rows of the extracted fare calculation data for the respective trip may be stitched together to create a single string of characters. Accordingly, a single string of characters may correspond to a single ticketed trip even if the ticketed trip may include one or more ONDs or segments. Based on these strings, a pattern with numbers with a decimal points is searched for. For each pattern found, a sequence number corresponding to its position is assigned. This sequence number may be utilized as an OND number for performing a match. In addition to the number search, a predetermined number (e.g., three) of alphabetic characters preceding the number pattern is obtained. This predetermined number of alphabetic characters correspond to a city or airport code of the OND.

In operation 616, matching operation is performed for each of the ONDS identified as a stopover based on the TOG. For example, the grouping operation may identify a first group of ONDs with TOG less than a predetermined threshold, a second group of ONDs with TOG of greater than the predetermined threshold. In this example, the second group of ONDs may be identified as stopovers. Matching operation may be performed for the ONDs identified as stopovers with parsed fare calculation airport codes, for prorating the respective ONDs based on the fare calculation data.

According to exemplary aspects, from transaction data associated with the ticketed trip, city code of the destination airport of an OND may be obtained, and the obtained city code is then matched with the city code included in the string of characters. Matching should be performed on both city codes and the OND number between the fare calculation data and the transactional data.

In operation 617, a determination of whether the OND matches with a parsed fare calculation airport code is made. If a match is found, the operation proceeds to operation 618. However, if no match is found, the operation proceeds to operation 622 on FIG. 6C.

In the case of an ARUNK in the transactional data, the next OND number and the destination city or airport code is in the source data is matched to the previous OND number and city code in the fare calculation OND. When a match is found, OND number of fares calculation OND is moved by 1, and an ARUNK segment found in the source/transactional data is inserted.

According to exemplary aspects, double ARUNKS may have some gaps in reassigning and may not get aligned between the TOG and the fare calculation. Ignore any additional OND or segment found in fare calculation when all ONDs and TOGs get aligned with fare calculation OND. According to exemplary aspects, this operation may be performed for each ARUNK segment found in the source/transactional data.

In operation 618, prorated fares for each of the ONDs included in the respective trip are summed up and compared against the total base fare or the original amount paid for the respective ticketed trip.

In operation 619, if the summed up prorated fares and the total base fare is determined to be greater than or equal to a reference threshold percentage (e.g., 90%) of the total base fare, then the method proceeds to operation 620. On the other than, if the summed up prorated fares is determined to be less than the reference threshold percentage of the total base fare, then the method proceeds to operation to operation 622 on FIG. 6C.

In operation 620, total base fare or total ticket amount is prorated and distributed to the true OND(s) based on the fare calculated percentage. According to exemplary aspects, each of the city codes found in operation 615 gets associated with the corresponding decimal value, and divided by the sum of all of the decimal values from all cities identified. The calculation results in expected percentage of the OND indicated in the ticketed trip.

In operation 621, the derived OND or true destinations are stored in data systems. More specifically, determined true destinations and/or corresponding ONDs (e.g., true or valid ONDs or segments, ARUNK ONDs and open ONDs) may be stored in a database. According to exemplary embodiments, ONDs or segments indicated on a trip ticket may or may not correspond to the ONDs or segments determined to be true ONDs or segments. In an example, the database may include a single database or a system of databased, which may be located locally, over a network or in a cloud network.

Upon storing of the derived OND or true destinations in operation 621, the method proceeds to operation 613 in FIG. 6A for updating capacity information of vehicles based on the derived segments or true destinations.

In operation 622, mileage based proration is applied to the grouped segments or true destinations. According to exemplary aspects, the mileage based proration may be performed using a big circle miles formula. More specifically, the mileage proration may calculate mileage between origin and destination airports of each leg of a trip. Then miles of all segments at both OND level and ticket level may be added to obtain miles of an OND and the total miles of the ticket. Then miles for each of the ONDs may be divided by the total miles to obtain an OND percentage. In this regard, any ARUNK segment ONDs will account for zero percentage share of the ticket.

In operation 623, fare amount is divided and distributed to the grouped segments of ONDs or true destinations accordingly.

In operation 624, the derived segments of ONDs or true destinations are stored in a database. More specifically, determined true destinations and/or corresponding ONDs (e.g., true or valid ONDs or segments, ARUNK ONDs and open ONDs) may be stored in a database. According to exemplary embodiments, ONDs or segments indicated on a trip ticket may or may not correspond to the ONDs or segments determined to be true ONDs or segments. In an example, the database may include a single database or a system of databased, which may be located locally, over a network or in a cloud network.

Upon storing of the derived OND or true destinations in operation 624, the method proceeds to operation 613 in FIG. 6A for updating capacity information of vehicles based on the derived segments or true destinations.

Although the present disclosure was made with respect to air travel involving airplanes and airports, aspects of the present disclosure are not limited thereto, such that they may be similarly applicable to rail travel, road travel or other transportations.

Further, although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for determining a true destination on a ticketed trip and updating a true vehicle capacity for one or more segments of the ticketed trip, the method comprising:
obtaining, by a processor, raw data corresponding to the ticketed trip from one or more sources;
parsing, by the processor, the raw data and deriving a plurality of segments making up the ticketed trip, each of the plurality of segments including an origin and a destination, and at least one connection point is present between the plurality of segments;
generating, by the processor, at least one stopover code based on attributes of the ticketed trip, the attributes including at least time-on-ground (TOG), domestic trip indicator, international trip indicator, and geographic location of an airport included in the plurality of segments;
grouping, by the processor, the plurality of segments based on the at least one stopover code;
creating, by the processor, a trip type for the ticketed trip based on the grouping;
performing, by the processor, a proration of the grouped segments of the ticketed trip;
dividing and distributing, by the processor, a fare for the ticketed trip according to the performed proration for the grouped segments of the ticketed trip;
identifying and storing, by the processor and into a memory, a true destination based on the grouping and the proration performed, wherein the true destination does not match with a destination indicated in the ticketed trip;
determining and updating, by the processor, a true capacity availability of a vehicle in on at least one of the plurality of segments based on the true destination of the ticked trip; and
displaying, on a display, the true capacity availability of the vehicle that differs from capacity availability of the vehicle indicated by the ticketed trip.

2. The method according to claim 1, wherein the proration is a segment based proration.

3. The method according to claim 2, wherein the segment based proration is performed by:
assigning equal percentage to each of the plurality of segments; and
applying a sum of the percentages to one or more segments among the plurality of segments that are included between the origin and the true destination.

4. The method according to claim 1, wherein the proration is a mileage based proration.

5. The method according to claim 4, wherein the milage based proration is performed by:
calculating mileage between an origin and destination of each of the plurality of segments;
adding miles of all of the plurality of segments to obtain total mileage for the ticketed trip;
dividing mileage of each of the plurality of segments by the total mileage to obtain a percentage of the ticketed trip for each of the plurality of segments; and
assigning zero percentage of the ticketed trip for an arrival unknown (ARUNK) segment.

6. The method according to claim 1, wherein the proration is a fare calculation based proration.

7. The method according to claim 6, wherein the fare calculation base proration is performed by:
cleaning fare calculation data and deleting duplicates;
stitching a plurality of rows of the cleaned fare calculation data to create one or more single strings of characters;
searching for patterns including numbers with a decimal value;
assigning a sequence number for each of the patterns found based on its respective position, wherein the sequence number assigned is used as a segment number for performing a match;
obtaining three alpha characters preceding the patterns, wherein the three alpha characters corresponding to a city code or airport code of a segment;
performing a match between the obtained three alpha characters and a segment number corresponding to a segment included in the plurality of segments; and
for each of the city code or airport code, associating the city code or the airport code with a corresponding decimal value, and dividing the respective decimal value by a sum of all decimal values for determining a percentage of the segment with respect to the ticketed trip.

8. The method according to claim 1, wherein the at least one stopover code is generated when the ticketed trip is a domestic trip and TOG is determined to be higher than a reference threshold.

9. The method according to claim 8, wherein the reference threshold is 8 hours for the domestic trip.

10. The method according to claim 1, wherein the at least one stopover code is generated when the ticketed trip is an international trip and TOG is determined to be higher than a reference threshold.

11. The method according to claim 10, wherein the reference threshold is 18 hours for the international trip.

12. The method according to claim 1, wherein the geographic location is a country.

13. The method according to claim 1, wherein the geographic location is a continent.

14. The method according to claim 1, wherein the true destination corresponds to a connecting airport that has the TOG above a reference threshold value for a domestic trip.

15. The method according to claim 1, wherein the true destination corresponds to a connecting airport that has the TOG above a reference threshold value for an international trip.

16. The method according to claim 1, wherein, when the TOG at a connecting airport is above a reference threshold, generating a new OND for a portion of the ticketed trip that indicates the true destination as the respective connecting airport, and identifying remaining portions of the ticked trip as an ARUNK segment with the respective connecting airport being indicated as an origin.

17. The method according to claim 1, wherein, when all of a segment based proration, a mileage based proration and a fare calculation based proration are available for the proration, selecting the fare calculation based proration first, the mileage based proration second and then the segment based proration last based on priority.

18. The method according to claim 17, wherein the proration determined by the fare calculation based proration is below another reference threshold value, reperforming proration using the mileage based proration.

19. A system for determining a true destination on a ticketed trip and updating a true vehicle capacity for one or more segments of the scheduled trip, the system comprising:
a memory;
a display; and
a processor,
wherein the system is configured to perform:
obtaining raw data corresponding to the ticketed trip from one or more sources;
parsing the raw data and deriving a plurality of segments making up the ticketed trip, each of the plurality of segments including an origin and a destination, and at least one connection point is present between the plurality of segments;
generating at least one stopover code based on attributes of the ticketed trip, the attributes including at least time-on-ground (TOG), domestic trip indicator, international trip indicator, and geographic location of an airport included in the plurality of segments;
grouping the plurality of segments based on the at least one stopover code;
creating a trip type for the ticketed trip based on the grouping;
performing a proration of the grouped segments of the ticketed trip;
dividing and distributing a fare for the ticketed trip according to the performed proration for the grouped segments of the ticketed trip;
identifying and storing a true destination based on the grouping and the proration performed, wherein the true destination does not match with a destination indicated in the ticketed trip;
determining and updating a true capacity availability of a vehicle in on at least one of the plurality of segments based on the true destination of the ticked trip; and
displaying the true capacity availability of the vehicle that differs from capacity availability of the vehicle indicated by the ticketed trip.

20. A method for determining a true fare for a ticketed trip, the method comprising:
obtaining, by a processor, raw data corresponding to the ticketed trip from one or more sources;
parsing, by the processor, the raw data and deriving a plurality of segments making up the ticketed trip, each of the plurality of segments including an origin and a destination, and at least one connection point is present between the plurality of segments;
generating, by the processor, at least one stopover code based on attributes of the ticketed trip, the attributes including at least time-on-ground (TOG), domestic trip indicator, international trip indicator, and geographic location of an airport included in the plurality of segments;
grouping, by the processor, the plurality of segments based on the at least one stopover code;
creating, by the processor, a trip type for the ticketed trip based on the grouping;
performing, by the processor, a proration of the grouped segments of the ticketed trip; and
dividing and distributing, by the processor, a fare for the ticketed trip according to the performed proration for the grouped segments of the ticketed trip,
wherein the proration is performed by:
cleaning fare calculation data and deleting duplicates;
stitching a plurality of rows of the cleaned fare calculation data to create one or more single strings of characters;
searching for patterns including numbers with a decimal value;
assigning a sequence number for each of the patterns found based on its respective position, wherein the sequence number assigned is used as a segment number for performing a match;
obtaining three alpha characters preceding the patterns, wherein the three alpha characters corresponding to a city code or airport code of a segment;
performing a match between the obtained three alpha characters and a segment number corresponding to a segment included in the plurality of segments; and
for each of the city code or airport code, associating the city code or the airport code with a corresponding decimal value, and dividing the respective decimal value by a sum of all decimal values for determining a percentage of the segment with respect to the ticketed trip.
